(19) United States
(12) Patent Application Publication
(10) Pub. No.: US 2007/0019797 A1
(43) Pub. Date: Jan. 25, 2007

(54) METHODS, SYSTEMS, AND COMPUTER PROGRAM PRODUCTS FOR PERFORMING A CONTEXT-BASED CALL ACTION IN RESPONSE TO AN INCOMING CALL INDICATION

(76) Inventor: Robert P. Morris, Raleigh, NC (US)

Correspondence Address: SCENERA RESEARCH, LLC, 111 CORNING RD., SUITE 220, CARY, NC, 27511, US

(21) Appl. No.: 11/160,565

(22) Filed: Jun. 29, 2005

(51) Int. Cl. H04M 3/42

(52) U.S. Cl. 379/202.01

(57) ABSTRACT

Methods, systems, and computer program products are disclosed for performing a context-based call action in response to an incoming call indication. An incoming call indication is received by a communication client during an active call between a first call participant and a second call participant. A context-based call action involving the second call participant is automatically performed in response to the incoming call indication. The incoming call indication is associated with a call placed by a calling party to the first call participant.

### TECHNICAL FIELD

The subject matter described herein relates to telephony. More particularly, the subject matter described herein relates to performing a context-based call action in response to an incoming call indication.

### BACKGROUND

According to conventional call waiting techniques, when two or more call participants are engaged in an active phone call and a new caller attempts to establish a new call with one of the call participants, the “called” participant is notified by a tone or other indication that another “call” is waiting. The called participant must interrupt the active call, engage the new caller, then return to the active call to either continue the active call or excuse himself/herself and terminate the active call. Another option is for the called participant is to simply ignore the incoming call. In addition, some conventional systems can be arranged to transfer the new caller to voice mail or to another number. Some other systems allow the called participant to manually play a recorded message to the other participants of the active call when accepting the new call. These solutions provide no information or limited information to the other call participants when an incoming call indication is received during an active call. Even in systems where some pre-recorded information is provided to the other call participants, manual intervention, such as switching to the incoming call, is required to carry out the notification.

Accordingly, there exists a need for methods, systems, and computer program products for automatically performing a context-based call action in response to an incoming call indication.

### SUMMARY

In one aspect of the subject matter disclosed herein, a method is disclosed for performing a context-based call action in response to an incoming call indication. The method includes receiving an incoming call indication by a communication client during an active call between a first call participant and a second call participant and automatically performing a context-based call action involving the second call participant in response to the incoming call indication. The incoming call indication is associated with a call placed by a calling party to the first call participant.

In another aspect of the subject matter disclosed herein, a system is disclosed for performing a context-based call action in response to an incoming call indication. The system includes means for receiving an incoming call indication during an active call between a first call participant and a second call participant and means for automatically performing a context-based call action involving the second call participant in response to the incoming call indication. The incoming call indication is associated with a call placed by a calling party to the first call participant.

In another aspect of the subject matter disclosed herein, a system is disclosed for performing a context-based call action in response to an incoming call indication. The system includes a communication client configured to receive an incoming call indication during an active call between a first call participant and a second call participant and a communication controller configured to automatically perform a context-based call action involving the second call participant in response to the incoming call indication. The incoming call indication is associated with a call placed by a calling party to the first call participant.

In another aspect of the subject matter disclosed herein, a computer program product is disclosed. The computer program product includes computer executable instructions embodied in a computer-readable medium. The computer executable instructions are for performing steps including receiving an incoming call indication by a communication client during an active call between a first call participant and a second call participant and automatically performing a context-based call action involving the second call participant in response to the incoming call indication. The incoming call indication is associated with a call placed by a calling party to the first call participant.

### BRIEF DESCRIPTION OF THE DRAWINGS

Objects and advantages of the present invention will become apparent to those skilled in the art upon reading this description in conjunction with the accompanying drawings, in which like reference numerals have been used to designate like elements, and in which:

FIG. 1 is a block diagram illustrating a call scenario in which the subject matter disclosed herein may be employed;

FIG. 2 is a block diagram illustrating a system for performing a context-based call action in response to an incoming call indication according to the subject matter described herein;

FIG. 3 is a flow diagram illustrating a method for performing a context-based call action in response to an incoming call indication according to an aspect of the subject matter described herein;

FIG. 4 is a flow diagram illustrating a method for performing a context-based call action in response to an incoming call indication according to another aspect of the subject matter described herein;

FIG. 5 is a flow diagram illustrating a method for performing a context-based call action in response to an incoming call indication according to another aspect of the subject matter described herein; and

FIG. 6 is a flow diagram illustrating a method for performing a context-based call action in response to an incoming call indication according to another aspect of the subject matter described herein.

### DETAILED DESCRIPTION

To facilitate an understanding of exemplary embodiments, many aspects are described in terms of sequences of actions that can be performed by elements of a computer system. For example, it will be recognized that in each of the embodiments, the various actions can be performed by specialized circuits or circuitry (e.g., discrete logic gates interconnected to perform a specialized function), by program instructions being executed by one or more processors, or by a combination of both.

Moreover, the sequences of actions can be embodied in any computer-readable medium for use by or in connection with an instruction execution system, apparatus, or device, such as a computer-based system, processor containing system, or other system that can fetch the instructions from a computer-readable medium and execute the instructions.

As used herein, a “computer-readable medium” can be any means that can contain, store, communicate, propagate, or transport the program for use by or in connection with the instruction execution system, apparatus, or device. The computer-readable medium can be, for example but not limited to, an electronic, magnetic, optical, electromagnetic, infrared, or semiconductor system, apparatus, device, or propagation medium. More specific examples (a non-exhaustive list) of the computer-readable medium can include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CDROM).

Thus, the subject matter described herein can be embodied in many different forms, and all such forms are contemplated to be within the scope of what is claimed.

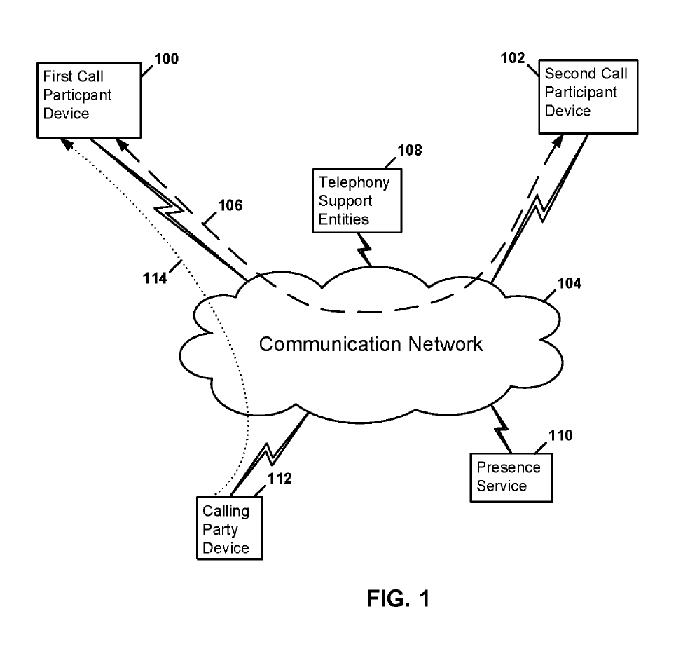

FIG. 1 is a block diagram illustrating a call scenario in which the subject matter disclosed herein may be employed. In FIG. 1, a first call participant 100 and a second call participant 102 are communicating via a communication network 104. That is, the first call participant 100 and the second call participant 102 are engaged in an active call 106.

Here, the term “call” refers to a communication session between two or more participants in which information is exchanged, is attempted to be exchanged, and/or is intended to be exchanged. The exchanged information can include voice data, video data, text, other multimedia-related services, or any other content or information. The active call 106 may be established and/or data may be exchanged with the aid of telephony support entities 108 communicating in the communication network 104. Some examples of telephony support entities 108 include signal transfer points, service control points, service switching points, gateways, servers, routers, and the like.

The communication network 104 may include, alone or in combination, an Internet protocol (IP) network enabling voice over IP technology, a public switched telephone network (PSTN) enabling signaling system 7 technology, or any suitable communication network and corresponding protocol. A presence service 110 may also be available for providing presence information via the communication network 104.

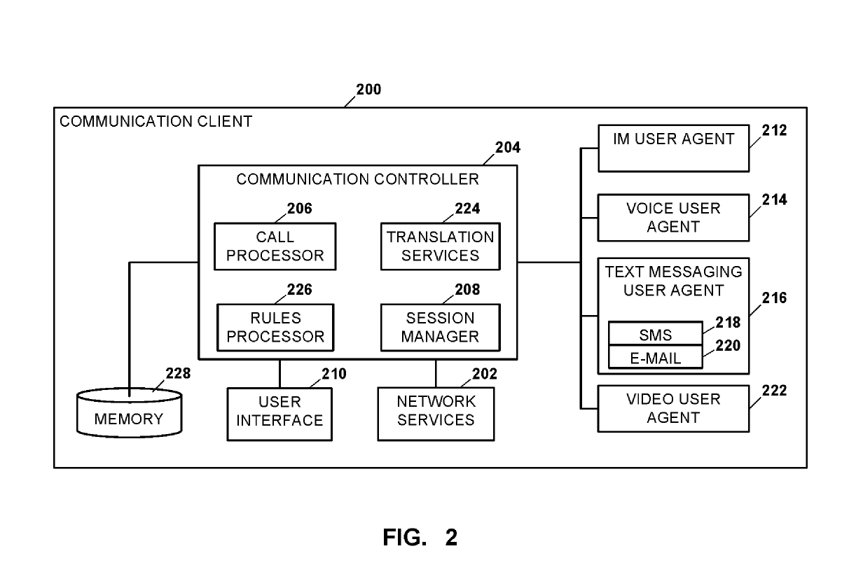

During the active call 106, a calling party 112 initiates a call to the first call participant 100. The first call participant 100 receives an incoming call indication 114 that is associated with the call initiated by the calling party 112. According to an aspect of the subject matter described herein, a context-based call action involving the second call participant 102 is performed automatically in response to the incoming call indication 114, as described further below in connection with FIGS. 1 and 2.

FIG. 2 is a block diagram illustrating a system for performing a context-based call action in response to an incoming call indication according to the subject matter described herein. The system includes means for receiving the incoming call indication 114 during the active call 106 between the first call participant 100 and the second call participant 102. For example, the system may include a communication client 200 configured to receive the incoming call indication 114 during the active call 106 between the first call participant 100 and the second call participant 102. The incoming call indication 114 is associated with the call placed by the calling party 112 to the first call participant 100. For example, the incoming call indication 114 may be a call waiting indication with or without caller-ID information currently available through telecommunication providers.

According to one aspect, the communication client 200 is included in the first call participant device 100. According to another aspect, the communication client 200 is located in the communication network 104 and is communicatively coupled to the first call participant 100 and the calling party 112. For example, the communication client 200 may instead be included in the telephony support entities 108. The communication client 200 includes a network services component 202 for interfacing to the communication network 104. The network services component 202 provides all the necessary protocols, applications, and hardware for communicating with remote entities via the communication network 104.

The system also includes means for automatically performing a context-based call action involving the second call participant 102 in response to the incoming call indication 114. For example, the system may include a communication controller 204 configured to automatically perform a context-based call action involving the second call participant 102. A context-based call action may include providing contextual information to the second call participant 102, providing contextual information to the calling party 112 that involves the second call participant 102, and/or automatically performing a context-based call action that involves the second call participant 102.

According to one aspect, the communication controller 204 may include a call processor 206 configured to determine contextual information associated with an incoming call indicated by the incoming call indication 114 and to provide the contextual information to the second call participant 102. For example, the contextual information associated with the incoming call may include the incoming call indication 114 to alert the second call participant 102 that another call is being received. The contextual information may include a calling party identifier that provides information about the calling party 112, such as an identity of the caller or information about the device used to place the call. The contextual information may include a call priority associated with the incoming call. For example, calls may be given different priority levels according to the calling party or calling party class, e.g., spouse, children, boss, friend, neighbor, unknown, etc. The contextual information may include a relationship identifier identifying a relationship between the calling party and the first call participant, e.g., wife, son, boss, etc. The contextual information may include a subject matter indicator associated with the incoming call. The subject matter indicator may be provided by the calling party 112 and/or via the user interface 210. The subject matter indicators may be selected from a predetermined list and/or may be customized via user input. The contextual information may include an indication that the active call will be terminated. For example, a message may be transmitted to the second call participant device 102 indicating that the active call 106 will be terminated in favor of the incoming call from calling party 112. Alternatively, the contextual information may include an indication that the incoming call will not be accepted and/or may include a request for the second call participant 102 to wait on hold. The contextual information may include an invitation to establish a communication session between the first call participant 100 and the second call participant 102 via an alternate communication means. For example, a voice or text message may be sent to the second call participant 102 inviting the second call participant 102 to communicate with the first call participant 100 via instant messaging. It should be understood that the contextual information may include any combination of the above-listed information.

The contextual information may be determined by the call processor 206 by examining information from one or more sources, such as information contained in the incoming call indication, information obtained in connection with establishing and managing the active call, information provided by the telephony support entities 108, and information input by a user of the first call participant device 100 via a user interface 210. The user interface 210 may include devices for audio input, such as a microphone, devices for alphanumeric input, such as a keyboard or keypad, devices for image input, such as a digital image capture device, and devices to allow a user to input other forms of user-related input. The information may be provided directly or through the communication network 104 via the network services component 202. The user interface 210 may also include devices for presenting information to a user, such as a display and/or a speaker.

In addition, the communication controller 204 may include a session manager 208 configured to manage communication sessions related to active and attempted calls. For example, the session manager 208 may be configured for establishing communication sessions, terminating communication sessions, placing communication sessions on hold, switching between communication sessions, switching modes of communication (such as switching between a voice communication session and an instant messaging communication session), and the like. To facilitate communication via different modes, communication client 200 may include an instant messaging user agent 212, a voice user agent 214, a text messaging user agent 216 that may include short messaging service support 218 and/or e-mail service support 220, and/or a video user agent 222.

According to another aspect, the call processor 206 may be configured to provide a second call participant response to the first call participant 100 and/or the calling party 112 in response to the contextual information provided to the second call participant 102. The response may be a message confirming receipt of the information, an acknowledgment indicating agreement or disagreement with the message content or may be a more elaborate response. For example, the message may be a text message or a voice message such as “Okay, I'll talk to you later” or “Yes, I'll contact you via IM”.

In another aspect, the call processor 206 may be configured to determine contextual information associated with the active call 106 and to automatically provide the contextual information to the calling party 112. Here, the contextual information associated with the active call 106 may include one or more pieces of information as described above. For example, the contextual information may include a second call participant identifier, a call priority associated with the active call 106, a relationship identifier identifying a relationship between the first call participant 100 and the second call participant 102, a subject matter indicator associated with the active call 106, an indication that the active call 106 will be terminated, an indication that the incoming call will not be accepted, a request to wait on hold, an indication of a future call between the first call participant 100 and the calling party 112, and an invitation to establish a communication session between the first call participant 100 and the calling party 112 via an alternate communication means.

According to another aspect, the call processor 206 may be configured to provide a calling party response to at least one of the first call participant and the second call participant in response to the contextual information provided to the calling party 112, analogous to the response framework described above.

In another aspect, the call processor 206 may be configured to compare contextual information associated with an incoming call with contextual information associated with the active call 106, and to automatically perform a context-based call action based on the comparison. For example, the call processor 206 may be configured to compare an identifier of the calling party 112 to an identifier of the second call participant 102. The call processor 206 may be configured to compare a call priority associated with the incoming call to a call priority associated with the active call 106. The call processor 206 may be configured to compare a relationship identifier identifying a relationship between the calling party 112 and the first call participant 100 to a relationship identifier identifying a relationship between the first call participant 100 and the second call participant 102. The call processor 206 may be configured to compare a subject matter indicator associated with the incoming call to a subject matter indicator associated with the active call 106. The call processor 206 may be configured to compare a presence status of the calling party 112 to a presence status of the second call participant 102. Here, the presence status information may be obtained from the presence service 110 via the communication network 104. The call processor 206 may be configured to compare a time of receipt associated with the incoming call to a time of receipt associated with the active call 106. Calls may be assigned more importance depending on when they were received such as late-night calls, calls while traveling, and the like. The call processor 206 may be configured to compare a point of origin of the incoming call to a point of origin of the active call 106.

In response to the comparison, the call processor 206 may automatically perform one or more context-based call actions. For example, the call processor 206 may be configured to provide a message to the calling party 112. The call processor 206 may be configured to provide a message to the second call participant 102. The call processor 206 may be configured to place the calling party 112 on hold. The call processor 206 may be configured to place the second call participant 102 on hold. The call processor 206 may be configured to join the calling party 112 to the active call 106. The call processor 206 may be configured to initiate an alternative communication session between the first call participant 100 and the calling party 112. The call processor 206 may be configured to initiate an alternative communication session between the first call participant 100 and the second call participant 102. The call processor 206 may be configured to request a future communication session between the first call participant 100 and the calling party 112 and/or between the first call participant 100 and the second call participant 102. The call processor 206 may be configured to translate between modes of communication. For example, communication controller 204 may include a translation services component 224 for translating between modes of communication, such as between voice, text, video, etc.

According to another aspect, the call processor 206 may be configured to automatically perform a context-based call action based on a presence status of at least one of the calling party 112, the first call participant 100, and the second call participant 102. For example, when the incoming call indication 114 is received, the call processor 206 may be configured to subscribe the calling party 112 to the presence service 110 to receive notifications of the first call participant's presence status so the calling party 112 will know when active call 106 is terminated and the first call participant 100 is available. Similarly, the call processor 206 may be configured to terminate the active call 106 and subscribe the second call participant 102 to the presence service 110 to receive notifications of the first call participant's presence status so the second call participant 102 will know when the first call participant 100 is available to continue the communication session. Alternatively, or in addition, the call processor 206 may terminate the active call 106 and subscribe the first call participant 100 to receive notifications of the second call participant's presence status for later communications, and/or to subscribe the first call participant 100 to receive notifications of the calling party's presence status for later communications.

According to a yet another aspect, the communication controller 204 may include a rules processor 226 configured to select a context-based call action to be performed based on predetermined rules associated with at least one of the first call participant 100, the second call participant 102, and the calling party 112. For example, a rule could be defined that provides that calls from a home telephone number or a spouse's cell phone would take priority over all other calls. Accordingly, in the example shown in FIG. 1, if the calling party 112 is the first call participant's spouse, rules processor 226 reads the corresponding rule from a memory 228 associated with the communication client 200 and, in conjunction with the call processor 206, automatically terminates the active call 106 and connects the incoming call. The memory 228 may also a configured to store a database of messages, priority mappings, rules, and/or alternate contact addresses for use by communication controller 204.

In another aspect, the predetermined rules may be determined by the rules processor 226 based on previous actions taken in connection with previous calls involving at least one of the first call participant 100, the second call participant 102, and the calling party 112. For example, if the last three times an incoming call indication was received from a spouse during an active call, the spouse's call was taken and the active call 106 was terminated, a rule giving calls from a spouse priority could automatically be generated by the rules processor 226 and saved in the memory 228 for future use.

It should be understood that the various components illustrated in FIG. 2 represent logical components that are configured to perform the functionality described herein and may be implemented in software, hardware, or a combination of the two. Moreover, some or all of these logical components may be combined and some may be omitted altogether while still achieving the functionality described herein.

Some or all of the actions described above may be performed automatically and may be selectively bypassed by one or more of the first call participant 100, the second call participant 102, and the calling party 112. In addition, each of the parties involved may send a message to one or more of the other parties. The parties may also be joined in one common communication session.

Some exemplary scenarios will now be described to illustrate scenarios in which the subject matter disclosed herein may be employed. In the four scenarios provided below, the first call participant 100 will be referred to as ‘A’, the second call participant 102 will be referred to as ‘B’, and the calling party 112 will be referred to as ‘C’, for ease of description.

Scenario 1: Active call between A and B, C calls, B automatically put on hold.

1) A and B are on an active call.
2) C places a call to A.
3) A's rules indicate that C has priority over all callers. (This may have been learned from A's past behavior.)
4) B is automatically put on hold and provided a message indicating that A has received an urgent call. The message asks B to wait for an update.
5) A receives a message that C is calling and A and C are connected. After 15 seconds of talking to C, A presses a button on user interface 210 to pop-up a message box for B. He types in, “B, C's on the line. I'll talk to you later.”
   Scenario 2: Active call between A and B, C calls, B puts self on hold.
1) A and B are on an active call.
2) C places a call to A.
3) A's rules indicate that all participants are to be notified of the status of all calls.
4) C and B are sent messages indicating that A and B are communicating, and C is waiting to communicate with A.
5) Knowing that C is annoyed with him, B immediately ends his call with A and presses an option that allows him to send a message to A that he is going out, so C won't find him at home.
6) Meanwhile, A and C have been connected. A receives B's message while talking to C.
7) A selects an option on user interface 210 to call B at any location his presence service determines he can be reached as soon as his call with C ends.
   Scenario 3: Active video call between A and B, C calls, A and B switch communication modes to instant messaging, A accepts call from C.
1) A and B are on an active video call.
2) C places a call to A.
3) A's rules indicate that he should be informed of who is calling. He is informed that it is C, with a message from C, “Answer the call, please.”
4) A hesitates. He doesn't want to end his call with B. A decides to switch his call with B to video instant messaging and accept C's call.
5) B was in the middle of saying something during the switch. His last words are translated from audio to text and are displayed to A in an instant messaging window.
6) An instant messaging window is displayed to B informing him that the call mode has switched to video instant messaging.
   Scenario 4: Active video call with audio between A and B, C calls, C gets video with instant messaging capability and switches to audio when A and B allow C to join their call.
1) Similar to Scenario 3 except A's rules state incoming calls should automatically be switched to instant messaging if the caller's client supports it. This can be determined through presence info (or other means) for the caller.
2) Thus A has a video feed to B with audio and a video feed to C with instant messaging.
3) A asks B if he's interested in joining his conversation with C and B accepts.
4) A indicates that C's instant messaging session should be translated to audio, creating a 3-way video conference.

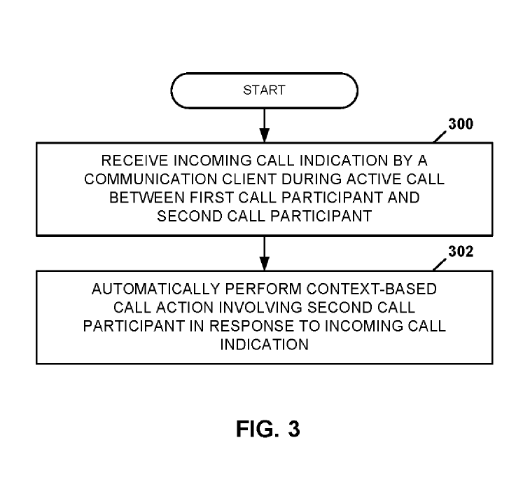

FIG. 3 is a flow diagram illustrating a method for performing a context-based call action in response to an incoming call indication according to an aspect of the subject matter described herein. In block 300, an incoming call indication is received by a communication client during an active call between the first call participant 100 and the second call participant 102. The incoming call indication is associated with a call placed by a calling party to the first call participant 100. A context-based call action involving the second call participant is automatically performed in block 302 in response to the incoming call indication.

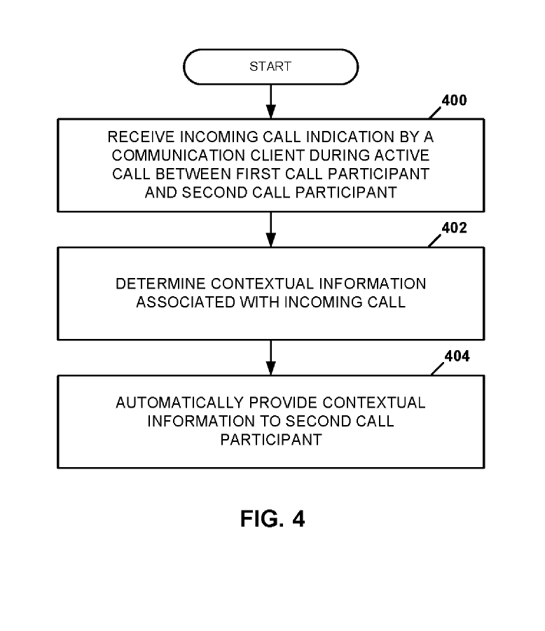

FIG. 4 is a flow diagram illustrating a method for performing a context-based call action in response to an incoming call indication according to another aspect of the subject matter described herein. In block 400, an incoming call indication is received by a communication client during an active call between the first call participant 100 and the second call participant 102. Contextual information associated with the incoming call is determined in block 402. The contextual information is automatically provided to the second call participant 102 in block 404.

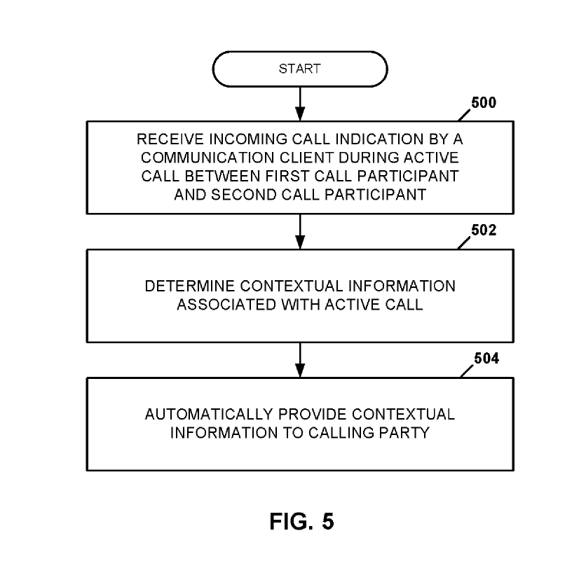

FIG. 5 is a flow diagram illustrating a method for performing a context-based call action in response to an incoming call indication according to another aspect of the subject matter described herein. In block 500, an incoming call indication is received by a communication client during an active call between the first call participant 100 and the second call participant 102. Contextual information associated with the active call 106 is determined in block 502. The contextual information is automatically provided to the calling party 112 in block 504.

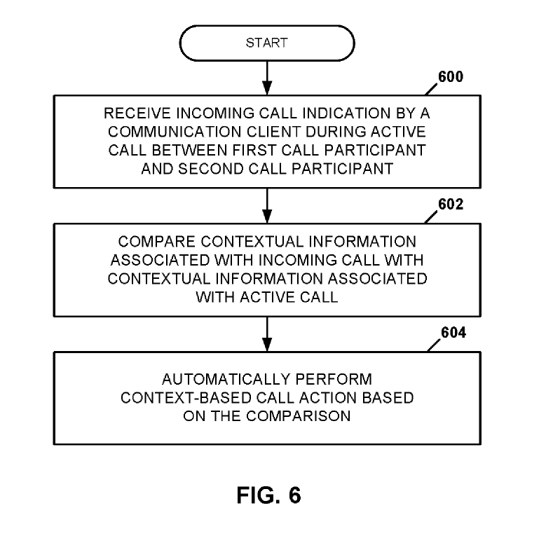

FIG. 6 is a flow diagram illustrating a method for performing a context-based call action in response to an incoming call indication according to another aspect of the subject matter described herein. In block 600, an incoming call indication is received by a communication client during the active call 100 between the first call participant 100 and the second call participant 102. Contextual information associated with the incoming call is compared with contextual information associated with the active call 106 in block 602. A context-based call action based on the comparison is automatically performed in block 604.

It will be understood that various details of the invention may be changed without departing from the scope of the claimed subject matter. Furthermore, the foregoing description is for the purpose of illustration only, and not for the purpose of limitation, as the scope of protection sought is defined by the claims as set forth hereinafter together with any equivalents thereof entitled to.

What is claimed is:

1. A method for performing a context-based call action in response to an incoming call indication, the method comprising:
receiving an incoming call indication by a communication client during an active call between a first call participant and a second call participant, the incoming call indication being associated with a call placed by a calling party to the first call participant; and
automatically performing a context-based call action involving the second call participant in response to the incoming call indication.

2. The method of claim 1 wherein receiving an incoming call indication by a communication client during an active call includes receiving the incoming call indication by a communication client at a communication device of the first call participant.

3. The method of claim 1 wherein receiving an incoming call indication by a communication client during an active call includes receiving the incoming call indication by a communication client in a communication network communicatively coupled to the first call participant and the calling party.

4. The method of claim 1 wherein automatically performing a context-based call action involving the second call participant comprises:
determining contextual information associated with an incoming call indicated by the incoming call indication; and
automatically providing the contextual information to the second call participant.

5. The method of claim 4 wherein the contextual information associated with the incoming call includes at least one of an incoming call indication, a calling party identifier, a call priority associated with the incoming call, a relationship identifier identifying a relationship between the calling party and the first call participant, a subject matter indicator associated with the incoming call, an indication that the active call will be terminated, an indication that the incoming call will not be accepted, a request to wait on hold, and an invitation to establish a communication session between the first call participant and the second call participant via an alternate communication means.

6. The method of claim 4 further comprising providing a second call participant response to at least one of the first call participant and the calling party in response to the contextual information provided to the second call participant.

7. The method of claim 1 wherein automatically performing a context-based call action involving the second call participant comprises:
determining contextual information associated with the active call; and
automatically providing the contextual information to the calling party.

8. The method of claim 6 wherein the contextual information associated with the active call includes at least one of a second call participant identifier, a call priority associated with the active call, a relationship identifier identifying a relationship between the first call participant and the second call participant, a subject matter indicator associated with the active call, an indication that the active call will be terminated, an indication that the incoming call will not be accepted, a request to wait on hold, an indication of a future call between the first call participant and the calling party, and an invitation to establish a communication session between the first call participant and the calling party via an alternate communication means.

9. The method of claim 7 further comprising providing a calling party response to at least one of the first call participant and the second call participant in response to the contextual information provided to the calling party.

10. The method of claim 1 wherein automatically performing a context-based call action involving the second call participant comprises:
comparing contextual information associated with an incoming call indicated by the incoming call indication with contextual information associated with the active call; and
automatically performing a context-based call action based on the comparison.

11. The method of claim 10 wherein comparing contextual information associated with the incoming call with contextual information associated with the active call includes comparing at least one of:
an identifier of the calling party to an identifier of the second call participant;
a call priority associated with the incoming call to a call priority associated with the active call;
a relationship identifier identifying a relationship between the calling party and the first call participant to a relationship identifier identifying a relationship between the first call participant and the second call participant;
a subject matter indicator associated with the incoming call to a subject matter indicator associated with the active call;
a presence status of the calling party to a presence status of the second call participant;
a time of receipt associated with the incoming call to a time of receipt associated with the active call; and
a point of origin of the incoming call to a point of origin of the active call.

12. The method of claim 10 wherein automatically performing a context-based call action based on the comparison comprises at least one of providing a message to the calling party, providing a message to the second call participant, placing the calling party on hold, placing the second call participant on hold, joining the calling party to the active call, initiating an alternative communication session between the first call participant and the calling party, initiating an alternative communication session between the first call participant and the second call participant, requesting a future communication session between the first call participant and the calling party, requesting a future communication session between the first call participant and the second call participant, and translating between modes of communication.

13. The method of claim 10 wherein automatically performing a context-based call action based on the comparison includes performing a context-based call action based on a presence status of at least one of the calling party, the first call participant, and the second call participant.

14. The method of claim 1 wherein automatically performing a context-based call action involving the second call participant in response to the incoming call indication includes selecting a context-based call action to be performed based on predetermined rules associated with at least one of the first call participant, the second call participant, and the calling party.

15. The method of claim 14 wherein the predetermined rules are determined based on previous actions taken in connection with previous calls involving at least one of the first call participant, the second call participant, and the calling party.

16. A computer program product comprising computer executable instructions embodied in a computer-readable medium for performing steps comprising:
receiving an incoming call indication by a communication client during an active call between a first call participant and a second call participant, the incoming call indication being associated with a call placed by a calling party to the first call participant; and
automatically performing a context-based call action involving the second call participant in response to the incoming call indication.

17. A system for performing a context-based call action in response to an incoming call indication, comprising:
means for receiving an incoming call indication during an active call between a first call participant and a second call participant, the incoming call indication being associated with a call placed by a calling party to the first call participant; and
means for automatically performing a context-based call action involving the second call participant in response to the incoming call indication.

18. A system for performing a context-based call action in response to an incoming call indication, comprising:
a communication client configured to receive an incoming call indication during an active call between a first call participant and a second call participant, the incoming call indication being associated with a call placed by a calling party to the first call participant; and
a communication controller configured to automatically perform a context-based call action involving the second call participant in response to the incoming call indication.

19. The system of claim 18 wherein the communication client is included in a device of the first call participant.

20. The system of claim 18 wherein the communication client is located in a communication network communicatively coupled to the first call participant and the calling party.

21. The system of claim 18 wherein the communication controller includes a call processor configured to determine contextual information associated with an incoming call indicated by the incoming call indication and to provide the contextual information to the second call participant.

22. The system of claim 21 wherein the contextual information associated with the incoming call includes at least one of an incoming call indication, a calling party identifier, a call priority associated with the incoming call, a relationship identifier identifying a relationship between the calling party and the first call participant, a subject matter indicator associated with the incoming call, an indication that the active call will be terminated, an indication that the incoming call will not be accepted, a request to wait on hold, and an invitation to establish a communication session between the first call participant and the second call participant via an alternate communication means.

23. The system of claim 21 wherein the communication controller includes a call processor configured to provide a second call participant response to at least one of the first call participant and the calling party in response to the contextual information provided to the second call participant.

24. The system of claim 18 wherein the communication controller includes a call processor configured to determine contextual information associated with the active call and to automatically provide the contextual information to the calling party.

25. The system of claim 23 wherein the contextual information associated with the active call includes at least one of a second call participant identifier, a call priority associated with the active call, a relationship identifier identifying a relationship between the first call participant and the second call participant, a subject matter indicator associated with the active call, an indication that the active call will be terminated, an indication that the incoming call will not be accepted, a request to wait on hold, an indication of a future call between the first call participant and the calling party, and an invitation to establish a communication session between the first call participant and the calling party via an alternate communication means.

26. The system of claim 24 wherein the communication controller includes a call processor configured to provide a calling party response to at least one of the first call participant and the second call participant in response to the contextual information provided to the calling party.

27. The system of claim 18 wherein the communication controller comprises a call processor configured to compare contextual information associated with an incoming call indicated by the incoming call indication with contextual information associated with the active call, and to automatically perform a context-based call action based on the comparison.

28. The system of claim 27 wherein the call processor is configured to compare at least one of:
an identifier of the calling party to an identifier of the second call participant;
a call priority associated with the incoming call to a call priority associated with the active call;
a relationship identifier identifying a relationship between the calling party and the first call participant to a relationship identifier identifying a relationship between the first call participant and the second call participant;
a subject matter indicator associated with the incoming call to a subject matter indicator associated with the active call;
a presence status of the calling party to a presence status of the second call participant;
a time of receipt associated with the incoming call to a time of receipt associated with the active call; and
a point of origin of the incoming call to a point of origin of the active call.

29. The system of claim 27 wherein the call processor automatically performs at least one of providing a message to the calling party, providing a message to the second call participant, placing the calling party on hold, placing the second call participant on hold, joining the calling party to the active call, initiating an alternative communication session between the first call participant and the calling party, initiating an alternative communication session between the first call participant and the second call participant, requesting a future communication session between the first call participant and the calling party, requesting a future communication session between the first call participant and the second call participant, and translating between modes of communication.

30. The system of claim 27 wherein the call processor automatically performs a context-based call action based on a presence status of at least one of the calling party, the first call participant, and the second call participant.

31. The system of claim 1 8 comprising a rules processor configured to select a context-based call action to be performed based on predetermined rules associated with at least one of the first call participant, the second call participant, and the calling party.

32. The system of claim 31 wherein the predetermined rules are determined by the rules processor based on previous actions taken in connection with previous calls involving at least one of the first call participant, the second call participant, and the calling party.
